(19) United States
(12) Patent Application Publication
(10) Pub. No.: US 2009/0217360 A1
(43) Pub. Date: Aug. 27, 2009

(54) Data Search System, data serach method, and recording medium storing data search program

(75) Inventors: Miyuki Tsuchiya, Fuji-shi (JP); Shizu Kanauchi, Yokohama-shi (JP)

Correspondence Address: HARNESS, DICKEY & PIERCE, P.L.C., P.O. BOX 8910, RESTON, VA, 20195, US

(73) Assignee: RICOH COMPANY, LTD

(21) Appl. No.: 12/379,225

(22) Filed: Feb. 17, 2009

(30) Foreign Application Priority Data
Feb. 26, 2008 (JP) 2008-044004

(51) Int. Cl. H04L 9/32; G06F 17/30; G06F 21/00

(52) U.S. Cl. 726/5; 707/3; 707/E17.014

(57) ABSTRACT

A data search system in which a data processing apparatus and a data search device are communicably connected includes an operational history acquisition unit to acquire operational history data including user data, information about current data processing and the document processed, and apparatus data, an apparatus data file storage unit to store an apparatus data file including the apparatus data and registered group data identifying a group that uses the data processing apparatus, a group-apparatus associator to associate the user data with the apparatus data file, a profile generator to generate a profile specifying significance degrees of the document in relation to the data processing apparatus and the group data, based on the operational history data, the apparatus data file, and the association, a profile storage unit to store the profile, and a data search unit to perform a data search according to a data search request from the user.

### CROSS-REFERENCE TO RELATED APPLICATIONS

This patent specification is based on and claims priority from Japanese Patent Application No. 2008-044004, filed on Feb. 26, 2008 in the Japan Patent Office, the entire contents of which are hereby incorporated by reference herein.

### BACKGROUND OF THE INVENTION

1. Field of the Invention

The present invention generally relates to a data search system, a data search method, and a recording medium storing a data search program.

2. Discussion of the Background Art

Recently, as digitalization of information enables users to access more and more information, a need has arisen to efficiently provide information according to the user's needs. To achieve this purpose, several approaches that are described below have been proposed.

In one known technique, each time a user processes document data (hereinafter also “document”) using a data processing apparatus, such as a scanner, a printer, or a multifunction machine, operational history of the data processing is stored for each user, characteristics of the data processing are extracted from the operational history, and a profile specifying significance of the document for each user is generated based on the extracted characteristics. When the user requests a data search, results of the data search performed according to the significance specified by the profile are provided.

In other words, in the known technique described above, the significance of the documents is set for each user, and data is provided according to the significance of the document for that user, or, in other words, according to user-specific significance of the document.

Here, however, it should be noted that information that is important for one particular community, group, or department and which is frequently referred to by a member thereof is not necessarily as important for another community, group, or department.

In view of the foregoing, in another known technique, reference history of documents is stored, and a score is given to each document based on the stored reference history and user-group association data associating a specific user and a group to which the user belongs. When the user requests a list of documents, the documents are selected according to their scores, and lists of selected documents are displayed. Thus, in this technique, the significance of the documents is set for each group, and information is provided according to the significance for each group in order to provide useful information for each user, or, in other words, according to group-specific significance of the document.

However, an additional complication is that the user might be affiliated simultaneously with more than one group. For example, in an office, a particular user may be in charge of multiple business matters, or may belong to multiple departments.

Thus, there is a need for a data search system that can provide useful information to the user more properly according to the group to which the user belongs.

### SUMMARY OF THE INVENTION

In view of the foregoing, one illustrative embodiment of the present invention provides a data search system in which a data processing apparatus to perform data processing of a document according to an operation by a user and a data search device that provides a data search are connected via a predetermined communication line. The data search system includes an operational history acquisition unit to acquire operational history data including user data identifying the user using the data processing the apparatus, information about current data processing and the document processed, and apparatus data identifying the data processing apparatus that executes the current data processing, an apparatus data file storage unit to store an apparatus data file including the apparatus data and registered group data identifying a group that uses the data processing apparatus, a group-apparatus associator to associate the user data with the apparatus data file, a profile generator to generate a profile in which significance degrees of the document processed by the data processing apparatus are set in relation to the data processing apparatus and the group data of the user, based on the operational history data, the apparatus data file, and an association established by the group-apparatus associator, a profile storage unit to store the profile generated by the profile generator; and a data search unit to perform a data search and provide results thereof to the data processing apparatus according to a data search request from the user.

In another illustrative embodiment of the present invention provides a data search method for providing a data search in which significance degrees of document data are set according to operational history of a data processing apparatus for performing data processing of the document data according to an operation by a user. The data search method includes acquiring operational history data including user data identifying the user using the data processing apparatus, information about current data processing and the document processed, and apparatus data identifying the data processing apparatus that executes the current data processing, associating the user data with an apparatus data file including the apparatus data and registered group data identifying a group registered to use the data processing apparatus, generating a profile in which significance degrees of the document processed by the data processing apparatus are set in relation to the data processing apparatus and the group data of the user, based on the operational history data, the apparatus data file, and an association between the user data with the apparatus data file, storing the profile in a profile storage unit; and performing a data search according to a data search request from the user based on the profile and providing results thereof.

Yet in another illustrative embodiment of the present invention provides a computer readable recording medium storing a data search program for executing the data search method described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a data search system according to an illustrative embodiment of the present embodiment;

FIG. 2 shows an example of apparatus data stored in an apparatus DB;

FIG. 3 shows examples of a profile stored in a profile DB;

FIG. 4 is a flowchart illustrating profile registration and updating;

FIG. 5 is a flowchart illustrating a sequence of data search processes including user authentication via a data processing apparatus;

FIG. 6 is a flowchart illustrating a sequence of data search processes without user authentication via a data processing apparatus; and

FIG. 7 is a flowchart illustrating a sequence of data search processes including user authentication via a network.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

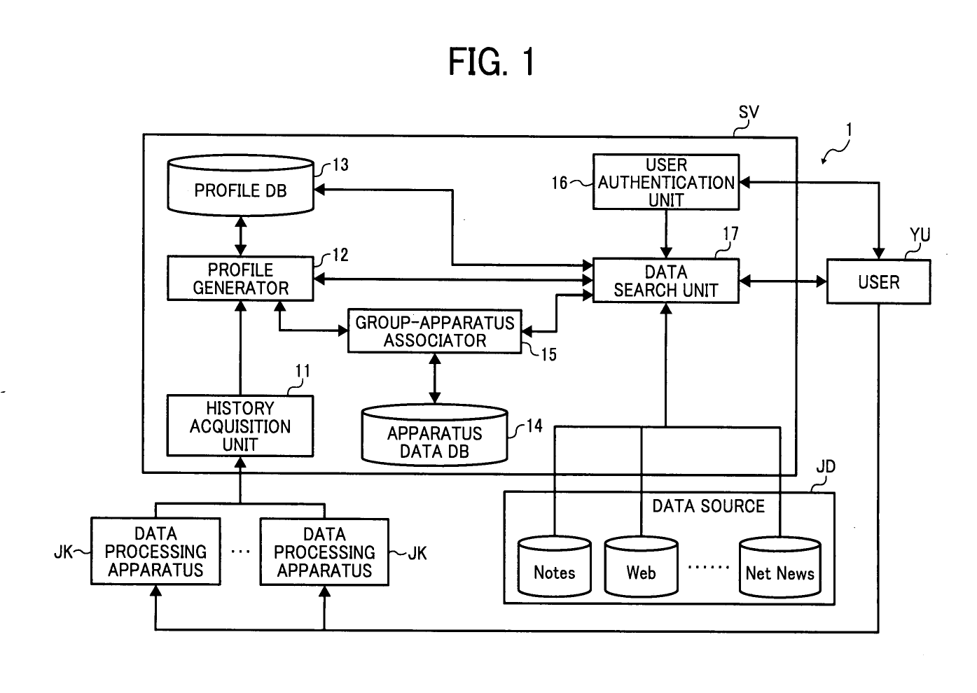

Referring now to the drawings, wherein like reference numerals designate identical or corresponding parts throughout the several views thereof, and particularly to FIG. 1, a data search system according to an illustrative embodiment of the present invention is described.

FIG. 1 is a block diagram illustrating a data search system 1 according to an example embodiment.

Referring to FIG. 1, the data search system 1 includes a data search server SV serving as a data search device and one or more data processing apparatuses JK that are connected to the data search server SV via a wired or wireless communication line such as the internet, a LAN (Local Area Network), and the like. The data search system 1 stores data processing history each time a user YU accesses or processes document data using the data processing apparatus JK for each user and performs data searches based on the data processing history and information about a group to which the user belongs, which is hereinafter referred to as group data.

The data processing apparatus JK is a device, such as a printer, a scanner, a facsimile machine, a digital multifunction machine, a computer, and the like, that is installed in an office and processes document information according to instructions by the user YU. The user YU can operate the data processing apparatus JK either directly or remotely via the network such as the internet, a LAN, and any wired or wireless communication line.

For example, the data processing apparatus JK that is a printer outputs document information printed on a sheet of paper according to the user's instructions.

Alternatively, the data processing apparatus JK that is a digital multifunction machine performs scanning, printing, copying, and/or facsimile transmission of the document information according to the user's instructions. When the user YU inputs his/her authentication data, such as a user identification (ID) number, password, and the like, that identifies the user YU thereto, the data processing apparatus JK provides the data search server SV with the authentication data.

Further, each data processing apparatus JK is provided with apparatus ID information, such as an apparatus ID number, that identifies itself and provides this apparatus ID information to the data search server SV at a given timing, such as when the user YU uses that data processing apparatus JK and when the user performs a data search therethrough.

The data search server SV can access an information source JD and includes an operational history acquisition unit (hereinafter simply “history acquisition unit”) 11, a profile generator 12, a profile database (DB) 13 serving as a profile storage unit, an apparatus DB 14 serving as an apparatus data file storage unit, a group-apparatus associator 15, a user authentication unit 16, and a data search unit 17.

The user YU processes the document data stored in the information source JD using the data processing apparatus JK, and the group data about the user YU is registered in the apparatus DB 14.

The usage history acquisition unit 11 executes operational history data acquisition in order to acquire operational history data regarding the data processing apparatus JK each time the user YU uses the data processing apparatus JK or regularly at a predetermined or given date or time. The user history acquisition unit 11 sends the operational history data to the profile generation unit 12.

It is to be noted that the operation history acquisition unit 11 can be provided as a function of either the information server SV or the data processing apparatus JK.

As the operational history data, the history acquisition unit 11 acquires user data identifying the user who operates the data processing apparatus JK, information about operations (data processing) performed by the data processing apparatus JK, document information identifying documents processed by the user YU, and apparatus data, such as the apparatus ID number, that identifies the data processing apparatus JK that executes the data processing.

The information about the operations can include date and time when the operation is executed, and the document information can include location of the document operated by the user YU. For example, when the user YU processes a document on a given website, the document information, includes its URL (Uniform Resource Locator).

The apparatus DB 14 can be stored on a hard disc and the like, and includes apparatus data files in which a particular data processing apparatus JK is associated with at lease one group registered to use that data processing apparatus JK.

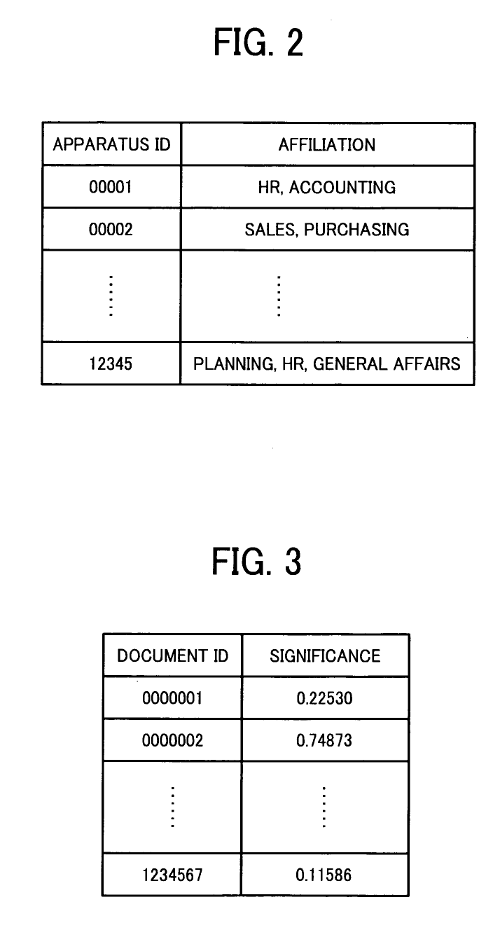

FIG. 2 shows an example of the apparatus data files.

In the example shown in FIG. 2, each unit of apparatus ID information (ID number) is associated with registered group data identifying the group(s) registered to use that data processing apparatus JK in the apparatus data files. For example, the data processing apparatus JK whose apparatus ID is “0001” is used by human resources (HR) section and accounting section. It is to be noted that, although only the apparatus ID numbers and registered group data are included in the apparatus data files in the example shown in FIG. 2, the apparatus DB 14 can include the group data of a particular user, that is, the group or groups to which a particular user belongs can be known from the apparatus DB 14.

Referring to FIGS. 1 and 2, when receiving the operational history data from the history acquisition unit 11, the profile generator unit 12 sends the user data (user ID number, etc.) and the apparatus data (apparatus ID number) to the group-apparatus associator 15 and requests therefrom an apparatus data file identifying the group to which the user YU who uses the data processing apparatus JK belongs.

When receiving the request for the group data, the group-apparatus associator 15 searches the apparatus DB 14 for the apparatus data file based on the user data and the apparatus data. Then, the group-apparatus associator 15 sends the apparatus data file corresponding to the apparatus data to the profile generator 12. This process is hereinafter referred to as group-apparatus association.

Herein, an identical user can belong to multiple groups simultaneously, that is, the group data of the user YU can include multiple groups. In this case, the group-apparatus associator 15 compares the group data of the user YU with the registered group data of that data processing apparatus JK. Then, the group-apparatus associator 15 selects the group included in both the group data of the user YU and the registered group data of that data processing apparatus JK and sends the apparatus data file corresponding to both the selected group and the apparatus data (apparatus ID number).

In other words, when an identical user YU belongs to multiple groups simultaneously, the group-apparatus associator 15 determines for which group the user YU performs the data processing, and obtains the apparatus data file corresponding to that group in order to send it to the profile generator 12.

Further, when the data search unit 17 requests the group data as well as information about both the user YU who performs a data search and the data processing apparatus JK that executes that data search, the group-apparatus associator 15 searches the apparatus DB 14 and sends the apparatus data file corresponding to the apparatus data. In this process, when the group data of the user YU includes multiple groups, the group-apparatus associator 15 compares the group data with the information about the groups that use that data processing apparatus JK similarly to the process described above. Then, the group-apparatus associator 15 selects the group that is included in both the group data of the user YU and the information about the groups that use that data processing apparatus JK and provides the data search unit 17 with the apparatus data file that corresponds to both the selected group and the apparatus data.

When receiving the apparatus data file identifying the group including the user YU who uses the data processing apparatus JK from the group-apparatus associator 15, the profile generator 12 generates a group profile or affiliation profile of that group as well as an apparatus profile of that data processing apparatus JK.

In this process, the profile generator 12 regards the operational history data sent from the history acquisition unit 11 as information that represents the group data and needs of the group that uses the data processing apparatus JK and sets degrees of significance (hereinafter “document significance degrees” or “significance data”) of the documents based on the operational history data such as the date and time of the operation, the number of times the document is processed, and the like. The group profile and the apparatus profile are stored in the profile DB 13.

Additionally, the profile generator 12 merges together the group profile and the apparatus profile both stored in the profile DB 13, generating an integrated profile in which the significance data included in both profiles are integrated.

An example of a method of generating the integrated profile can be normalization through predetermined or given formulas such as simple addition and simple multiplication. For example, when the document significance degrees of the group profile and the apparatus profile are respectively X and Y, the document significance degrees are normalized through a formula AX+BX so as to generate an integrated profile, wherein A and B represent coefficients that determine which of the group profile and the apparatus profile is more significant. It is to be noted that the document significance degrees in the integrated profile can be adjusted by adjusting those coefficients A and B.

FIG. 3 shows an example of the group profile generated by the profile generator 12 and stored in the profile DB 13.

In the profile shown in FIG. 3, each document ID identifying a particular document is provided with a significance degree that represents the digitalized significance of that document for a particular group, for example, the HR department. In a case of the apparatus profile, each document ID can be provided with a significance degree for the particular data processing apparatus JK. The profile generator 12 generates such a profile for each group and for each data processing apparatus JK and stores them in the profile DB 13.

It is to be noted that, although only the document ID and significance degrees for a particular group (e.g. HR department) are included in the example shown in FIG. 3, the group profile can include the group for which the significance degrees are set and data on ownership of documents, that is, the group that owns a particular document can be known from the group profile.

An example of a method of digitalization of the significance degree is as follows: When the significance degree is indicated by numerical values within a range from 0 to 1 as an example, a document whose significance is highest is provided with a significance value 1, and a document whose significance is lowest is provided with a significance value 0. That is, as higher the significance, the closer to 1 the significance value is. In the digitalization of the significance, the profile generator 12 can arrange the documents simply in order of the number of times the documents are printed. Alternatively, the profile generator 12 can increase the significance of the document when a particular user processes that document.

It is to be noted that, although the profile DB 13 and the apparatus DB 14 are included in the data search server SV in the present embodiment, such a configuration is just one example thereof. Alternatively, either or both the profile DB 13 and the apparatus DB 14 can be provided on the side of the user YU, such as in the data processing apparatus JK or in a separate terminal, or on the side of an external service provider that provides a data search service. Alternatively, either or both the profile DB 13 and the apparatus DB 14 can be physically dispersed via the network not limited to the case in which they are physically included in the data search server SV.

When the user inputs his/her user data (user ID number, etc.) and the password via the data processing apparatus JK and requests user authentication, the user authentication unit 16 performs a user authentication process. In the user authentication process, the user authentication unit 16 authenticates the user YU based on the user data and the password input thereto. When the user authentication has succeeded, the user authentication unit 16 transmits the user data to the group-application associator 15 and requests the group data of that user YU.

Subsequently, as described above, the group-apparatus associator 15 acquires the apparatus data file regarding the group corresponding to the user data, that is, the apparatus data file regarding the group to which the user YU belongs), and transmits this apparatus data file to the user authentication unit 16. Then, the user authentication unit 16 transmits this apparatus data file corresponding to the group to which the authenticated user YU belongs to the data search unit 17 as well as the profile generator 12.

When the user YU requests a data search using the data processing apparatus JK, the data search unit 17 performs a data search process. In the data search process, the data search unit 17 retrieves corresponding profiles from among all profiles stored in the profile DB 13, searches for the document requested by the user YU according to the significance data included in the profile, and then sorts the retrieved documents according to a predetermined or given classification format. Then, the data search unit 17 transmits a search result to the data processing apparatus JK that requests the data search.

Additionally, in the data search process, different search methods are used depending on whether or not the user YU requests the user authentication process in the data search request, whether or not the terminal via which the user YU requests the data search request is the data processing apparatuses JK whose apparatus data is registered in the apparatus DB 14, and the like.

More specifically, when the user YU requests a data search using a given data processing apparatus JK without user authentication, the data search unit 17 searches the profile DB 13 for a profile corresponding to the apparatus data (apparatus ID) of the data processing apparatus JK via which the data search is requested. Subsequently, the data search unit 17 searches for the document requested by the user YU according to the significance data included in the retrieved profile and sorts retrieved documents according to the predetermined or given classification format. Then, the data search unit 17 transmits a search result to the data processing apparatus JK that requests the data search.

By contrast, when the user YU requests user authentication and a data search using a given data processing apparatus JK, the data search unit 17 searches the profile DB 13 for a profile corresponding to both his/her user data and the apparatus data (apparatus ID) of that data processing apparatus JK. Subsequently, the data search unit 17 searches for the document requested by the user YU according to the significance data included in the retrieved profile and sorts retrieved documents according to the predetermined or given classification format. Then, the data search unit 17 transmits a search result to the data processing apparatus JK that requests the data search. In this process, when the user data includes multiple groups, the data search unit 17 transmits a request for designation of group to that data processing apparatus JK. Then, the data search unit 17 retrieves a profile corresponding to the designated group and a profile corresponding to the apparatus data.

Further, when the user YU requests user authentication and a data search using a given terminal other then the data processing apparatus JK, that is, an apparatus data file thereof being not registered in the apparatus DB 14, via a web application or the like, the data search unit 17 searches the profile DB 13 for a profile corresponding only to the user data of the authenticated user YU.

The information source JD includes databases on web sites, groupware, and the like, storing various information. The data search unit 17 accesses the information source JD and searches for particular information.

The data search system 1 described above can be configured as a system that performs data searches by loading a data search program stored on a computer-readable recording medium, which executes a data search method according to the present embodiment, onto the data search server SV or the data processing apparatus JK.

Examples of the computer-readable recording medium includes a ROM (Read Only Memory), an EEPROM (Electrically Erasable and Programmable ROM), EPROM (Erasable and Programmable ROM), a flush memory, a flexible disc, a CD-ROM (Compact Disc ROM), CD-RW (Compact Disc Rewritable), a DVD (Digital Video Disk), a SD (Secure Digital) card, and a MO (Magneto-Optical Disc).

The data search program is a computer-executable program described in a legacy programming language, such as an assembler language, C language, C++ language, C# language, and Java (registered trademark), an object-oriented programming language, or the like. The data search program can be stored on the recording medium and can be distributed.

As a feature of the present embodiment, the data search system 1 according to the present embodiment can identify information needs of the group that uses the data processing apparatus JK, that is, information needs of respective departments and/or sections in an office, using the operational history data regarding the data processing apparatus JK, and can reflect the identified information needs to results of data searches. In particular, when the user YU belongs to multiple groups (departments or sections), the data search system 1 can determine for which group a particular data search is performed. Thus, the group's information needs can be reflected to results of the data search.

Various processes performed by the data search system 1 shown in FIG. 1 are described below.

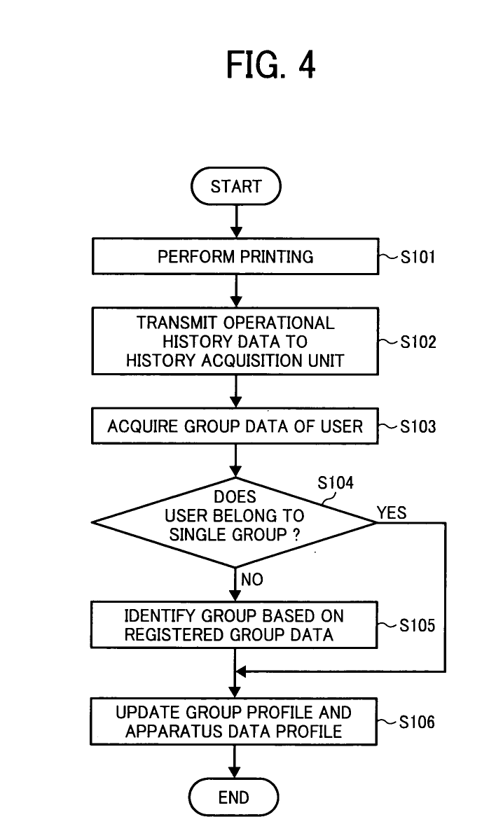

FIG. 4 is a flowchart illustrating a sequence of processes performed in profile registration and updating.

It is to be noted that, although the processes shown in FIG. 4 concern a case in which the data processing apparatus JK performs printing, the operation performed by the data processing apparatus JK is not limited thereto but can be any data processing operation.

Referring to FIGS. 1 and 4, when the user YU performs printing using the data processing apparatus JK at S101, at S102 the data processing apparatus JK transmits information about this operation (current data processing), such as date and time of this operation, and information about a printed document, the user YU who has printed the document, and the data processing apparatus JK that has executed the printing, as operational history data to the history acquisition unit 11 of the data search server SV. Then, the history acquisition unit 11 transmits the operational history data to the profile generator 12.

Subsequently, the profile generator 12 transmits the user data (user ID, etc.) and the apparatus data (apparatus ID, etc.) to the group-apparatus associator 15 and, at S103, requests the group data of the user JK (apparatus data file) therefrom. The group-apparatus associator 15 searches the apparatus DB 14 for a corresponding apparatus data file based on the user data and the apparatus data, and, at S104, checks whether or not there is data about only a single group to which the user YU belongs, that is, whether or not the user YU belongs to only a single group.

When there is data about only a single group (YES at S104), the group-apparatus associator 15 retrieves the apparatus data file corresponding to both the user data and the apparatus data, and transmits this apparatus data file to the profile generator 12.

By contrast, when there is data about multiple groups, that is, the user YU belongs to multiple groups (NO at S104), the group-apparatus associator 15 retrieves the registered group data of that data processing apparatus JK from the apparatus data file stored in the apparatus DB 14.

At S105 the group-apparatus associator 15 compares this registered group data with the group data of the user YU, identifies for which group the user YU performs the current data processing, and then retrieves the apparatus data file corresponding to the identified group. Thus, the group relating to the current data processing is selected from among the multiple groups to which the user belongs. The apparatus data file thus retrieved is transmitted to the profile generator 12.

After receiving the group data about the user YU (apparatus data file), the profile generator 12 sets the significance degrees based on the operational history data transmitted from the history acquisition unit 11 and generates a group profile (affiliation profile) of that group and an apparatus profile of that data processing apparatus JK.

At S106, these profiles (current profiles) are stored in the profile DB 13. In this process, when previously generated profiles (previous profiles) regarding that user YU and that data processing apparatus JK are stored in the profile DB 13, the profile generator 12 updates the previous profiles to the current profiles.

As described above, in the present embodiment, each time the user YU operates the data processing apparatus JK, the data search server SV acquires the operational history data and updates the profiles stored in the profile DB 13 according to the group data of that user YU and the operational history data.

Further, the data search server SV uses different search methods for the following cases: Case A, in which the user YU performs user authentication and then requests a data search via the data processing apparatus JK; case B, in which the user YU requests a data search without user authentication using the data processing apparatus JK; and case C, in which the user YU performs user authentication and requests a data search via a given terminal that is not the data processing apparatus JK whose apparatus data is registered in the apparatus DB 14.

A sequences of data search processes performed in each of the above-described cases A, B, and C is described below.

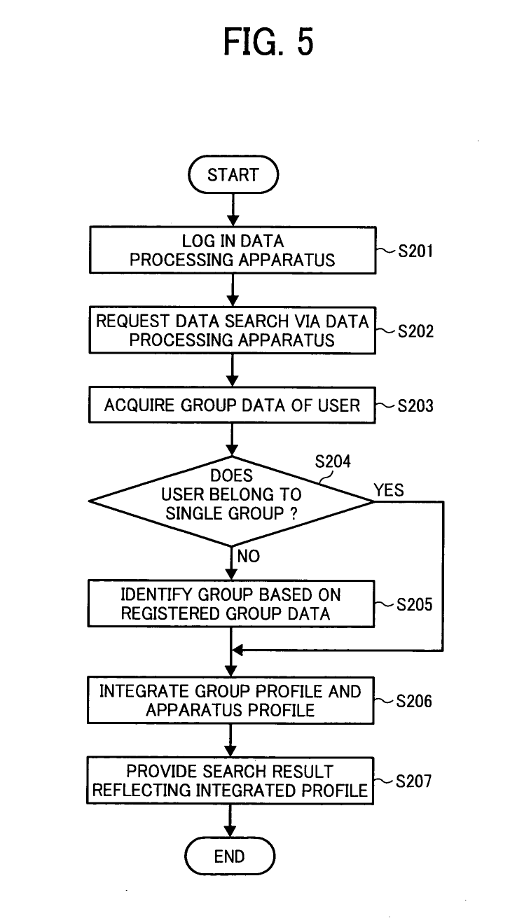

FIG. 5 is a flowchart illustrating the sequence of the data search processes performed in the case A.

Referring to FIGS. 1 and 5, at S201 the user YU logs in the data processing apparatus JK, that is, inputs his/her user data (user ID) and password to the data processing apparatus JK and requests user authentication. Then, the user authentication unit 16 authenticates the user YU based on the input user data (user ID) and password.

After the user authentication has succeeded, at S202 the user requests a data search (current data search) via the data processing apparatus JK, and then the data search server SV determines that the current data search is requested via the data processing apparatus JK.

Subsequently, the user authentication unit 16 transmits the user data and the apparatus data of that data processing apparatus JK to the group-apparatus associator 15 and, at S203, requests the group data therefrom. Then, the group-apparatus associator 15 searches the apparatus data file stored in the apparatus DB 14 based on the received user data and the apparatus data and, at S204, checks whether or not the retrieved apparatus data file includes information about only a single group to which the user YU belongs.

When there is data about only a single group (YES at S204), the group-apparatus associator 15 retrieves the apparatus data file corresponding to both the user data and the apparatus data, and transmits this apparatus data file to the data search unit 17.

By contrast, when there is data about multiple groups, that is, the user YU belongs to multiple groups (NO at S204), the group-apparatus associator 15 retrieves the registered group data of that data processing apparatus JK from the apparatus data files stored in the apparatus DB 14.

Subsequently, at S205 the group-apparatus associator 15 compares this registered group data with the group data of the user YU in order to identify the group for which the user YU performs the current data search from the multiple groups. Then, the group-apparatus associator 15 retrieves the apparatus data file corresponding to the identified group and transmits this apparatus data file to the data search unit 17.

When receiving the group data regarding the user YU who uses the data processing apparatus JK, the data search unit 17 acquires the group profile and the apparatus profile that correspond to the identified group and the currently used data processing apparatus JK from the profile DB 13 and then transmits these profiles to the profile generator 12.

At S206, the profile generator 12 merges together the group profile and the apparatus profile, generating an integrated profile in which the significance degrees set in the respective profiles are integrated. The integrated profile is transmitted to the data search unit 17.

Subsequently, the data search unit 17 performs the data search according to the significance data set in the integrated profile and sorts results thereof according to a predetermined or given classification method. Then, the data search unit 17 transmits the search result to the data processing apparatus JK that has requested the current data search. At S207, the data processing apparatus JK provides the search result reflecting the integrated profile to the user YU, for example, by displaying the results on a display such as a LCD (Liquid Crystal Display). Data search processes are then completed.

As described above, the data search system 1 according to the present embodiment acquires the operational history data that includes the user data identifying the user YU who performs data processing, the information about the data processing (operation) performed and the document processed, and the apparatus data identifying the data processing apparatus JK that executes the data processing.

Further, in the present embodiment, the apparatus data file stored in the apparatus DB 14 includes the apparatus data and the group registered to use that data processing apparatus JK. Additionally, from the apparatus BD 14, the group or groups to which a particular user belongs can be known. The data search system 1 associates the user data with the apparatus data file. Based on the operational history data and the association between the user data and the apparatus data file, the information search system 1 sets the significance degrees of the documents to be processed by the data processing apparatus JK in relation to both that data processing apparatus JK and the group data of the user YU, generates the profiles reflecting the significance degrees, and then stores this profile in the profile DB 13. When the user YU (current user) requests a data search, the data search system 1 provides search results reflecting the profile stored in the profile DB 13.

Thus, even when the user YU belongs to multiple groups, the data search system 1 can search for information useful for each group to which the user YU belongs and provide results thereof to the user YU.

Additionally, in the data search system 1 according to the present embodiment, when apparatus data files includes multiple groups, that is, the user YU belongs to the multiple groups, the group-apparatus associator 15 identifies the group relating to the current data processing from the multiple groups, based on the group data of the user YU and the apparatus data of the data processing apparatus JK used by that user YU. Then, the group-apparatus associator 15 associates the user data with the apparatus data file.

Thus, even when the user YU belongs to multiple groups, the data search system 1 can identify the group for which the user YU performs current data processing, associate the user data and the apparatus data file, and then generate a profile.

Further in the above-described case in which apparatus data file includes the multiple groups, the data search unit 17 acquires the profile corresponding to the group identified by the group-apparatus associator 15 and proves search results reflecting that profile.

Thus, even when the user YU belongs to multiple groups, the data search system 1 can use proper search conditions and provide information useful for a specific group from the multiple groups.

The profile generator 12 further integrates the significance data relating to both the data processing apparatus JK and the group including the user YU using that data processing apparatus JK, generating an integrated profile.

In other words, a profile reflecting the significance of for both the data processing apparatus JK used and the group to which the user YU belongs can be generated, and thus a more useful search result can be provided.

Additionally, the user authentication unit 16 authenticates the user YU based on the predetermined or given authentication data such as the user data and the password. When the user authentication has succeeded, the user authentication unit 16 acquires the group data of the user YU from the apparatus data files stored in the apparatus DB 14 based on the authentication data, and the data search unit 17 provides a search result reflecting the profile corresponding to the group data acquired by the user authentication unit 16.

Thus, the data search system 1 according to the present embodiment can identify the user YU and provide a search result useful for the group including the identified user YU.

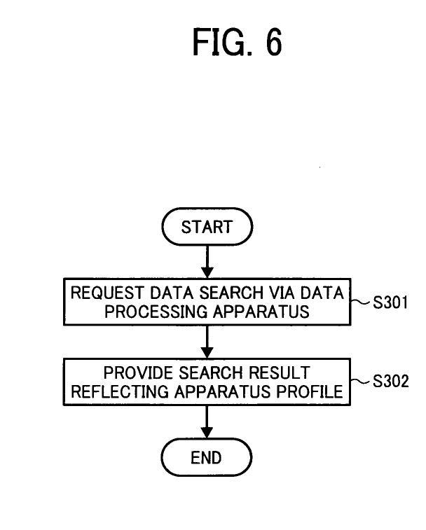

Next, the case B in which the user YU requests a data search without user authentication using the data processing apparatus JK is described below with reference to FIG. 6.

FIG. 6 is a flowchart illustrating a sequence of the data search processes performed in the case B.

Referring to FIGS. 1 and 6, at S301 the user YU requests a data search using the data processing apparatus JK without requesting user authentication on the display thereof. Then, the data processing apparatus JK transmits the data search request and its apparatus data (apparatus ID) to the data search unit 17. Alternatively, when the history acquisition unit 11 is provided on the data search server SV, the history acquisition unit 11 can acquire the data search request and the apparatus data and then transmit them to the data search unit 17. Then, the data search unit 17 determines that the data search has requested from the data processing apparatus JK and acquires the apparatus profile from the profile DB 13.

Subsequently, the data search unit 17 performs the data search according to the significance data set in the apparatus profile, and then sorts results thereof according to the predetermined or given classification method. At S302 the data search unit 17 provides the search result thus reflecting the apparatus profile to the user YU, for example, by displaying it on the display (LCD) of the data processing apparatus JK, and then the processes are completed.

As described above, in the data search system 1 according to the present embodiment, when the data processing apparatus JK transmits a data search request before the user authentication unit authenticates the user YU, the data search unit 17 performs the data search according to the profile corresponding to the data processing apparatus JK and provides the search result.

Therefore, the data search can be performed according to the profile relating to the data processing apparatus JK used by that user YU, and thus a useful search result can be obtained even when the user authentication is not performed.

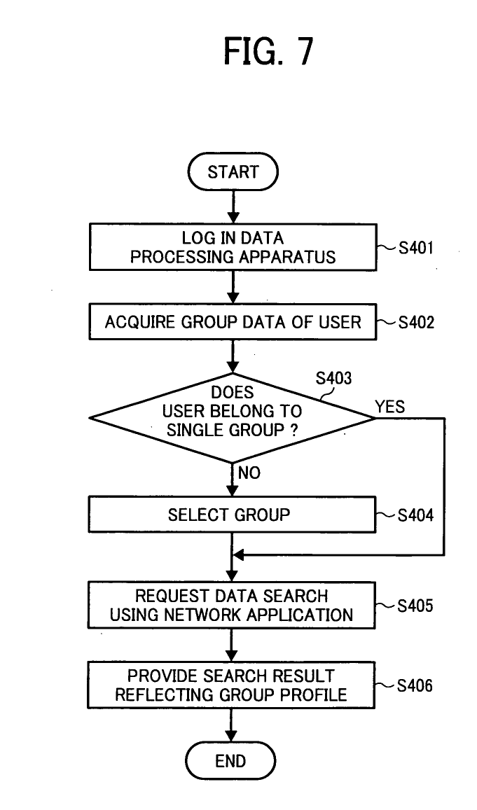

Next, the case C in which the user YU requests both user authentication and a data search using a web application through a terminal other than the data processing apparatus JK is described below with reference to FIG. 7.

FIG. 7 is a flowchart illustrating a sequence of the data search processes performed in the case C.

Referring to FIGS. 1 and 7, at S401 the user YU requests user authentication, that is, logs in a terminal, such as a computer, that is not the data processing apparatus JK registered on the data search server SV and requests a data search using a web application from that terminal. Then, the user authentication unit 16 authenticates the user YU based on the user data and the password. When the user authentication has succeeded, the data search server SV determines that the data search has requested on the network.

At S402 the user authentication unit 16 transmits the user data to the group-apparatus associator 15 and requests the group data of the user YU. Then, the group-apparatus associator 15 searches the apparatus data files stored in the apparatus DB 14 based on the user data and, at S403, checks whether or the user YU belongs to only a single group.

When the user YU belongs to only a single group (YES at S403), the group-apparatus associator 15 transmits the apparatus data file corresponding to the user data to the data search unit 17. When receiving the group data of the user YU from the group-apparatus associator 15, the data search unit 17 acquires the group profile corresponding to the group data from the profile DB 13.

By contrast, when the user YU belongs to multiple groups (NO at S403), the group-apparatus associator 15 displays a message prompting the user YU to select one of the multiple groups on a user interface of the web application via the data search unit 17.

At S404 the user YU selects one of the groups according to the message and requests the data search. Then, the web application transmits the selected group and the data search request to the data search server SV. When receiving the selected group and the data search request, the data search unit 17 acquires the group profile corresponding to the selected group from the profile DB 13.

At S405 the data search unit 17 performs the data search reflecting the significance information set in the acquired group profile, sorts results thereof according to the predetermined or given classification method, and transmits the search result to the web application that has requested the data search.

At S406 the web application provides the search result reflecting the group profile to the user YU, for example, by causing the terminal that has requested the current data search to display the search result. Then, the processes are completed.

As described above, in the data search system 1 according to the present embodiment, when the user YU requests user authentication and a data search via a terminal other than the data processing apparatus JK, the data search unit 17 provides a data search result reflecting the profile corresponding to the group including the user YU thus authenticated.

Thus, even when the user YU requests user authentication and a data search from a terminal other than the data processing apparatus JK using a web application and the like, the data useful for the group to which the user YU belongs can be provided.

The present invention can be adapted to a data search system for providing a data search correlating the document data used via a particular data processing apparatus, such as a scanner, a printer, and a multifunction machine, and the group to which the user belongs, a data search method, a data search program, and a recording medium storing the data search program.

Numerous additional modifications and variations are possible in light of the above teachings. It is therefore to be understood that, within the scope of the appended claims, the disclosure of this patent specification may be practiced otherwise than as specifically described herein.

What is claimed is:

1. A data search system in which a data processing apparatus to perform data processing of a document according to an operation by a user and a data search device that provides a data search are communicably connected,
the data search system comprising:
an operational history acquisition unit to acquire operational history data including user data identifying the user using the data processing the apparatus, information about current data processing and the document processed, and apparatus data identifying the data processing apparatus that executes the current data processing;
an apparatus data file storage unit to store an apparatus data file including the apparatus data and registered group data identifying a group registered to use the data processing apparatus;
a group-apparatus associator to associate the user data with the apparatus data file;
a profile generator to generate a profile in which significance degrees of the document processed by the data processing apparatus are set in relation to the data processing apparatus and the group data of the user, based on the operational history data, the apparatus data file, and an association established by the group-apparatus associator;
a profile storage unit to store the profile generated by the profile generator; and
a data search unit to perform a data search and provide results thereof to the data processing apparatus in accordance with a data search request from the user.

2. The data search system according to claim 1, wherein, when the apparatus data file includes multiple groups to which the user belongs, the group-apparatus associator identifies the group relating to the current data processing from among the multiple groups based on the group data of the user and the apparatus data of the data processing apparatus operated by the user, and associates the user data with the apparatus data file.

3. The data search system according to claim 2, wherein, when the apparatus data file includes multiple groups to which the user belongs, the data search unit provides results obtained by performing the data search based on a profile relating to the group identified by the group-apparatus associator from the profile storage unit.

4. The data search system according to claim 1, wherein the profile generator generates an integrated profile in which the significance degrees respectively set in relation to the data processing apparatus and in relation to the group data of the user are integrated.

5. The data search system according to claim 1, further comprising a user authentication unit to authenticate the user based on predetermined authentication data,
wherein, when the authentication is successful, the user authentication unit acquires the group data of the user from the apparatus data file stored in the apparatus data file storage unit based on the authentication data, and
the data search unit provides results obtained by performing the data search based on the profile corresponding to the acquired group data.

6. The data search system according to claim 5, wherein, when the data processing apparatus requests a data search before the user authentication unit performs user authentication, the data search unit provides a data search result reflecting the profile corresponding to the data processing apparatus.

7. The data search system according to claim 1, wherein, when the operational history acquisition unit acquires new operational history data, the profile generator generates a profile in which significance degrees of the documents are set based on the new operational history data.

8. A data search method for providing a data search in which significance degrees of document data are set according to operational history of a data processing apparatus for performing data processing of the document data in accordance with an operation by a user,
the data search method comprising;
acquiring operational history data including user data identifying the user using the data processing apparatus, information about current data processing and the document processed, and apparatus data identifying the data processing apparatus that executes the current data processing;
associating the user data with an apparatus data file including the apparatus data and registered group data identifying a group registered to use the data processing apparatus;
generating a profile in which significance degrees of the document processed by the data processing apparatus are set in relation to the data processing apparatus and the group data of the user, based on the operational history data, the apparatus data file, and an association between the user data with the apparatus data file;
storing the profile in a profile storage unit; and
performing a data search according to a data search request from the user based on the profile and providing results thereof.

9. The data search method according to claim 8, wherein, when the data processing apparatus data file includes multiple groups to which the user belongs, one of the multiple groups is identified as the group relating to the current data processing based in the group data and the apparatus data, and the apparatus data file is associated with the identified group.

10. The data search method according to claim 9, wherein, when the data processing apparatus data file includes multiple groups to which the user belongs, the method retrieves a profile corresponding to the identified group from the profile storage unit, performs the data search based on the profile, and provides results of the data search.

11. The data search method according to claim 8, wherein an integrated profile in which the significance degrees respectively set in relation to the data processing apparatus and in relation to the group data of the user are integrated is generated as the profile.

12. The data search method according to claim 8, further comprising:
performing user authentication based on predetermined authentication data; and
acquiring the group data of the user from the apparatus data file based on the authentication data when the user authentication has succeeded,
wherein the data search is performed based on the profile corresponding to the acquired group data.

13. A computer readable recording medium storing a data search program for executing a data search method for providing a data search in which significance degrees of document data are set according to operational history of a data processing apparatus for performing data processing of the document data in accordance with to an operation by a user,
the data search method comprising;
acquiring operational history data including user data identifying the user using the data processing apparatus, information about current data processing and the document processed, and apparatus data identifying the data processing apparatus that executes the current data processing
associating the user data with an apparatus data file including the apparatus data and registered group data identifying a group registered to use the data processing apparatus;
generating a profile in which significance degrees of the document processed by the data processing apparatus are set in relation to the data processing apparatus and the group data of the user, based on the operational history data, the apparatus data file, and an association between the user data with the apparatus data file;
storing the profile in a profile storage unit; and
performing a data search according to a data search request from the user based on the profile and providing results thereof.
